(19) United States
(12) Patent Application Publication
(10) Pub. No.: US 2013/0051689 A1
(43) Pub. Date: Feb. 28, 2013

(54) IMAGE ENCODING APPARATUS, IMAGE ENCODING METHOD AND PROGRAM

(71) Applicants: Kazuhiro SHIMAUCHI, Tokyo (JP); Takahiro Sato, Tokyo (JP); Hiroshi Ikeda, Kanagawa (JP)

(72) Inventors: Kazuhiro SHIMAUCHI, Tokyo (JP); Takahiro Sato, Tokyo (JP); Hiroshi Ikeda, Kanagawa (JP)

(73) Assignee: Sony Corporation, Tokyo (JP)

(21) Appl. No.: 13/545,654

(22) Filed: Jul. 10, 2012

(30) Foreign Application Priority Data
Aug. 25, 2011 (JP) 2011-183556

(51) Int. Cl. G06K 9/36

(52) U.S. Cl. 382/232

(57) ABSTRACT

There is provided an image encoding apparatus including an encoding part performing encoding processing on each image processing unit including a plurality of encoding units and generating encoded data, and a sorting/marker-inserting part sorting the encoding units in the encoded data in encoding processing order for one screen and inserting a marker as a delimiter for encoding processing using a correlation with an immediately preceding encoding unit.

### BACKGROUND

The present technology relates to an image encoding apparatus, an image encoding method and a program, specifically, when generating encoded data in which markers are inserted as delimiters for compression processing, capable of reducing a buffer capacity and facilitating the generation of the encoded data in which the markers are inserted.

Image capturing devices such as a digital camera perform image processing on an image signal as an imaging result and perform encoding processing after accumulating the data for one screen in a buffer in the past. This is due to the fact that general image encoding methods represented by JPEG (Joint Photographic

Experts Group) often employ encoding of an image for one screen in raster order. A buffer with a large amount of memory capacity, however, is strongly recommended for holding the image data for one screen. In Japanese Patent No. 4273426 (hereinafter referred to as Patent Literature 1), the memory capacity of the buffer is reduced using a technique of first performing the image processing and encoding processing on image processing units and, after that, sorting the image processing units in the encoded data in regular order.

### SUMMARY

The general encoding methods such as JPEG include encoding of differences between DC values (direct current component values) of MCUs (Minimum Coding Units). Therefore, decoding the encoded data starting from its middle portion expects previous generation of the encoded data in which the encoding side inserts markers as delimiters for compression processing, for example, restart markers used for resetting the correlations between the MCUs.

When generating the encoded data in which the restart markers are inserted, since the amount of the codes increases by the restart markers, increase of the buffer capacity in which the encoded data is temporarily stored for the sorting of the encoded data is strongly recommended. Moreover, since the narrower the interval of the insertion of the restart markers becomes, the more the amount of the codes of the restart markers increases, the buffer capacity should be increased more. Moreover, in case that JPEG is employed, indices of restart markers should repeat “0” to “7” in raster order in one screen. Therefore, the generation of the encoded data in which the restart markers are inserted after the image processing and encoding processing on the image processing units as in Patent Literature 1 should be followed by rearrangement of indices of the restart markers in raster order in one screen according to the sorting of the encoded data.

Accordingly, it is desirable to provide an image encoding apparatus, an image encoding method and a program capable of, when generating encoded data in which markers are inserted as delimiters for compression processing, reducing a buffer capacity and facilitating the generation of the encoded data in which the markers are inserted.

According to the first embodiment of the present technology, there is provided an image encoding apparatus including an encoding part performing encoding processing on each image processing unit including a plurality of encoding units and generating encoded data, and a sorting/marker-inserting part sorting the encoding units in the encoded data in encoding processing order for one screen and inserting a marker as a delimiter for encoding processing using a correlation with an immediately preceding encoding unit.

In the present technology, the encoding processing on each image processing unit constituted of a plurality of encoding units is performed and the encoded data is generated. For example, the image processing such as scaling and rotation of an image for each image processing unit is performed and, after that, the encoding processing is performed on each image processing unit in the image after the image processing. When performing the rotation of the image, the image processing conducts the rotation of each image processing unit or each encoding unit. The encoded data generated by the encoding processing is sorted in encoding processing order for one screen and, in it, markers, that is, restart markers for resetting correlations with immediately preceding encoding processing units are inserted. Moreover, the encoding processing is performed using the correlations with the immediately preceding encoding units in encoding processing order for one screen, whereas the encoding processing is performed without using the correlations with the immediately preceding encoding units for the encoding units immediately after marker insertion positions. When performing the encoding processing using the correlation with the immediately preceding encoding unit, for example, a direct current component value obtained by the encoding processing on the immediately preceding encoding unit in encoding processing order for one screen is stored. And then, using the stored direct current component value, the encoding processing on the encoding unit as the encoding object is performed. Moreover, when performing the encoding processing on each image processing unit, in the case that a direct current component value of the encoding unit immediately before the encoding unit at the leftmost end in the image processing unit in encoding processing order for one screen is not stored before the encoding processing on the encoding unit at the leftmost end, the direct current component value of the immediately preceding encoding unit is previously acquired. As to the encoding unit immediately after the marker insertion position, for example, the encoding processing is performed without using the correlation with the immediately preceding encoding unit by setting the direct current component value of the immediately preceding encoding unit to “0.”

According to the second embodiment of the present technology, there is provided an image encoding method including performing encoding processing on each image processing unit including a plurality of encoding units and generating encoded data, and sorting the encoding units in the encoded data in encoding processing order for one screen and inserting a marker as a delimiter for encoding processing using a correlation with an immediately preceding encoding unit.

According to the third embodiment of the present technology, there is provided a program causing a computer to perform encoding of an image, causing the computer to execute performing encoding processing on each image processing unit including a plurality of encoding units and generating encoded data, and sorting the encoding units in the encoded data in encoding processing order for one screen and inserting a marker as a delimiter for encoding processing using a correlation with an immediately preceding encoding unit.

In addition, a program according to the present technology is a program capable of being provided via a recording medium or a communication medium providing various programs and codes, for example, to a general purpose computer executable of these in a computer-readable format, for example, a recording medium such as an optical disk, a magnetic disk and a semiconductor memory, or a communication medium such as a network. Such a program realizes a computer performing processes according to the program, provided in a computer-readable format.

According to the present technology, the encoding processing on each image processing unit constituted of a plurality of encoding units is performed and the encoded data is generated. Moreover, the encoding units in the encoded data are sorted in encoding processing order for one screen and, in it, markers as delimiters for the encoding processing using correlations with immediately preceding encoding processing units are inserted. Thus, since the markers are inserted after the sorting of the encoded data in encoding processing order for one screen, the buffer capacity temporarily storing the encoded data can be reduced. Moreover, since the markers are inserted after the sorting of the encoded data in encoding processing order for one screen, rearrangement of the indices of the markers in a predetermined order in one screen is not needed and the generation of the encoded data in which the marker are inserted is performed readily.

### BRIEF DESCRIPTION OF THE DRAWINGS

FIG. 1 is a diagram illustrating a configuration in case of application to an image capturing apparatus;

FIG. 2 is a flowchart illustrating a process of an image recorded in a storage;

FIGS. 3A and 3B are diagrams for explaining decoding processing for an image processing unit;

FIG. 4 is a diagram for explaining a process of contraction of an image;

FIG. 5 is a diagram illustrating a process of rotation and expansion of an image;

FIGS. 6A and 6B are diagrams for explaining encoding processing for each image processing unit;

FIG. 7 exemplarily illustrates encoding of MCUs 7, 8 and 9;

FIGS. 8A to 8C are diagrams illustrating sorting of encoded data;

FIGS. 9A to 9D are diagrams illustrating a process of an image constituted of MCUs A1 to A6, B1 to B6 and C1 to C6;

FIG. 10 is a flowchart illustrating control processing of direct current component values in a first operation;

FIGS. 11A and 11B are diagrams illustrating restart markers inserted in the middle of image processing units;

FIG. 12 exemplarily illustrates encoding of MCUs 7, 8 and 9;

FIG. 13 exemplarily illustrates encoding of MCUs 10, 11 and 12;

FIGS. 14A to 14C are diagrams illustrating sorting of encoded data;

FIGS. 15A to 15D are diagrams illustrating a process of an image constituted of MCUs A1 to A6, B1 to B6 and C1 to C6;

FIG. 16 is a flowchart illustrating control processing of direct current component values in a second operation;

FIGS. 17A and 17B are diagrams illustrating rotation of an image by 180 degrees in image processing;

FIG. 18 is a diagram for explaining sorting processing in the case of the rotation of the image by 180 degrees; and

FIG. 19 is a diagram for explaining sorting processing in case that restart markers are inserted in the middle of image processing units.

### DETAILED DESCRIPTION OF THE EMBODIMENT(S)

In addition, the description will be made in the following order:

### 1. Configuration of Image Encoding Apparatus

### 2. Operations of Image Encoding Apparatus

### 3. First Encoding Processing Operation for Each Image Processing Unit

### 4. Second Encoding Processing Operation for Each Image Processing Unit

### 5. Third Encoding Processing Operation for Each Image Processing Unit

### 6. In Case of Software Processing

### (1. Configuration of Image Encoding Apparatus)

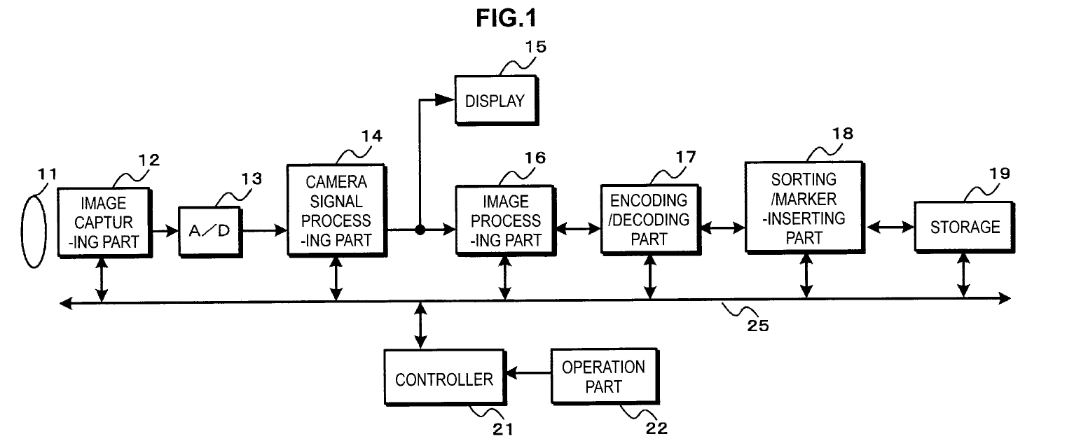

FIG. 1 illustrates a configuration in which an image encoding apparatus according to the present technology is applied to an image capturing apparatus. An image capturing apparatus 10 includes an image capturing optical system 11, an image capturing part 12, an analog/digital (A/D) converter 13, a camera signal processing part 14, a display 15, an image processing part 16, an encoding/decoding part 17, a sorting/marker-inserting part 18 and a storage 19. The image capturing apparatus 10 further includes a controller 21 and an operation part 22. Moreover, to a bus 25, the camera signal processing part 14, the image processing part 16, the encoding/decoding part 17, the sorting/marker-inserting part 18, the storage 19, the controller 21 and the like are connected.

The image capturing optical system 11 concentrates incident light using zoom magnification, a focus and an aperture stop according to control of the controller 21 to form an optical image of a subject on an imaging plane of the image capturing part 12.

The image capturing part 12 employs a solid-state image sensor, for example, such as a CMOS (Complementary Metal Oxide Semiconductor) image sensor and a CCD (Charge Coupled Device) image sensor. The image capturing part 12 performs photoelectric conversion to output an imaging signal according to the optical image formed on the imaging plane of the image sensor to the A/D converter 13.

The A/D converter 13 performs analog/digital conversion processing on the imaging signal outputted from the image capturing part 12. The A/D converter 13 outputs image data generated by performing the analog/digital conversion processing to the camera signal processing part 14.

The camera signal processing part 14 performs camera signal processing, for example, such as matrix calculation processing, white balance adjustment processing and gamma correction processing on the image data outputted from the A/D converter 13. The camera signal processing part 14 outputs the image data after the camera signal processing to the display 15 and the image processing part 16.

The display 15 performs image display based on the image data supplied from the camera signal processing part 14 or the image data supplied from the image processing part 16.

The image processing part 16 performs image processing, for example, such as resizing processing for scaling up or down an image by converting its resolution, image rotation processing for rotating an image, and trimming processing for extracting part of an image on the image data supplied from the camera signal processing part 14. The image processing part 16 outputs the image data after the image processing to the encoding/decoding part 17. Moreover, the image processing part 16 performs the image processing of the image data supplied from the encoding/decoding part 17, and displays a reproduction image of an image, for example, recorded in the storage 19 by outputting the image data after the image processing, for example, to the display 15.

The encoding/decoding part 17 performs encoding processing and/or decoding processing according to an instruction of the controller 21. The encoding/decoding part 17 performs the encoding processing, for example, using a JPEG method which is one of encoding methods based on variable-length coding techniques on the image data after the image processing supplied from the image processing part 16 to generate encoded data and to output it to the sorting/marker-inserting part 18. Moreover, the encoding/decoding part 17 decodes encoded data inputted from the sorting/marker-inserting part 18 to output image data obtained by the decoding to the image processing part 16. In these processes, the encoding/decoding part 17 notifies an amount of generated codes and the like to the controller 21 for each MCU which is an encoding processing unit. Moreover, when a DC value detected in the MCU is to be used in the later encoding processing of an MCU, the encoding/decoding part 17 stores the detected DC value. In addition, since the detected DC value and a DC value acquired by previous acquisition processing mentioned below may be stored so that they can be used simply in the later encoding processing, they are stored, for example, in the encoding/decoding part 17, the controller 21 or the like.

The encoding/decoding part 17 encodes a difference value between a DC value of an immediately preceding MCU in encoding processing order for one screen and a DC value of an MCU of the encoding object. Furthermore, the encoding/decoding part 17 resets a correlation between MCUs by previously replacing a DC value which an MCU immediately after a restart marker insertion position refers to by “0.” The encoding/decoding part 17 encodes a difference value between the DC value “0” and the DC value of the MCU of the encoding object, that is, the DC value of the MCU of the encoding object. In addition, the MCU immediately after the restart marker insertion position is referred to as an MCU of the reset object in the following description.

The sorting/marker-inserting part 18 includes a memory, temporarily stores the encoded data supplied from the encoding/decoding part 17 in the memory, and sorts encoding units in the encoded data in encoding processing order for one screen. The sorting/marker-inserting part 18 outputs the encoded data after the sorting to the storage 19, and moreover outputs the encoded data supplied from the storage 19 to the encoding/decoding part 17. Further, the sorting/marker-inserting part 18 inserts a delimiter of compression processing, that is, a restart marker for resetting a correlation with an immediately preceding encoding processing unit in the encoded data after the sorting according to an instruction of the controller 21. In addition, in the sorting of the encoded data, the sorting/marker-inserting part 18 rewrites position information for identifying the positions of the individual MCUs such as a slice start code and a block code and/or control codes used for the decoding processing in response to the sorting according to an instruction of the controller 21.

The storage 19 includes a recording medium, for example, such as a memory card, an optical disk and a magnetic disk. The storage 19 records the encoded data supplied from the sorting/marker-inserting part 18 in the recording medium. Moreover, the storage 19 reads out the encoded data recorded in the recording medium to output to the sorting/marker-inserting part 18.

The controller 21 includes a ROM (Read Only Memory), a RAM (Random Access Memory), a CPU (Central Processing Unit) and the like. The controller 21 executes a program stored in the ROM to control the individual parts so that the image capturing apparatus 10 operates according to user operations in the operation part 22. Moreover, the controller 21 secures a work area in the RAM to perform the operation control. In addition, the processing program is not limited to be provided by previous installation but may be provided by recording in a recording medium such as an optical disk, a magnetic disk and a memory card or provided by downloading via a network such as the Internet.

### (2. Operations of Image Encoding Apparatus)

Next, operations of the image encoding apparatus when the image encoding apparatus is applied to the image capturing apparatus are described.

The controller 21 controls operations of the individual parts according to user operations in the operation part 22, for example, to cause the image capturing part 12 to capture images sequentially and to cause the display 15 to display monitor images, and moreover controls operations of the individual parts according to user's shutter operations, when recording still images in the storage 19, to cause the image processing part 16 and/or the encoding/decoding part 17 and the sorting/marker-inserting part 18 to process image data of the still images and to cause the storage 19 to record them.

Moreover, the controller 21, when the user instructs image processing, controls operations of the individual parts to cause the storage 19 to record the image after the image processing. Herein, the image processing part 16 performs the image processing using an image processing unit suitable for the process. The encoding/decoding part 17 sequentially performs the encoding processing on the image processing result supplied from the image processing part 16 to generate encoded data. The sorting/marker-inserting part sorts encoding units in the encoded data in encoding processing order for one screen to output to the storage 19. Moreover, when performing the image processing of the image recorded in the storage 19, the encoding/decoding part 17 decodes the encoded data recorded in the storage 19 and the image processing part 16 performs the image processing on it. The encoding/decoding part 17 performs the encoding processing on the processing results and the storage 19 records it. At this stage, the controller 21 repeats the decoding processing, image processing and encoding processing of the imaging results recorded in the storage 19 for every image processing unit and in processing order which are suitable for the process in the image processing part 16. Moreover, the controller 21 causes the sorting/marker-inserting part 18 to sort the encoded data obtained by the process repetition of these in encoding processing order for one screen and causes the storage 19 to record it.

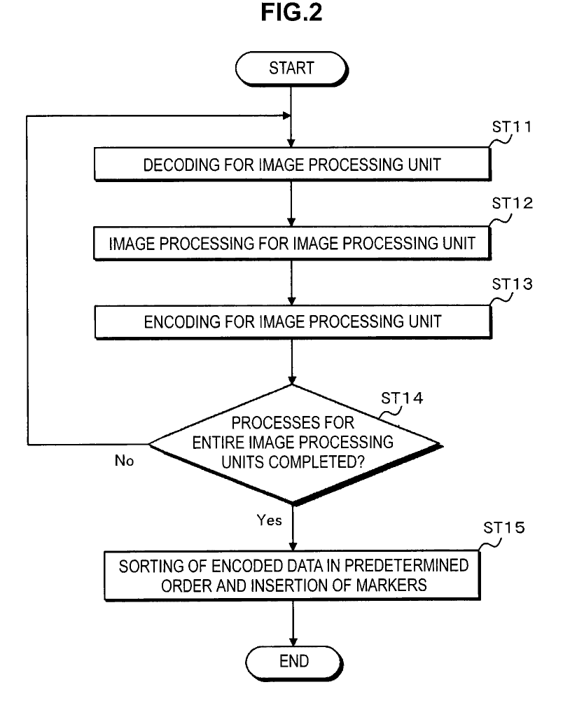

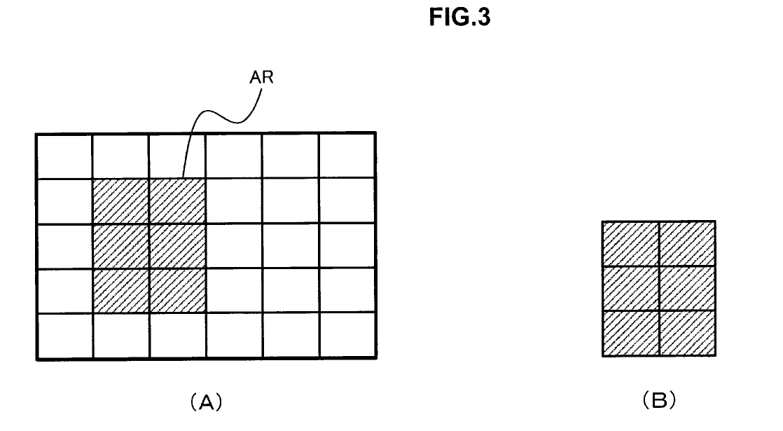

FIG. 2 is a flowchart illustrating a process of an image recorded in the storage 19. In step ST11, the controller 21 performs the decoding for an image processing unit. The controller 21 causes the storage 19 to read out an encoded data piece for the image processing unit and causes the encoding/decoding part 17 to perform the decoding. For example, regarding each block illustrated in FIG. 3A as the image processing unit, in the case of the image processing of a region AR indicated by a shaded portion according to the instruction of the controller 21, the encoding/decoding part 17 performs the decoding processing of each image processing unit illustrated in FIG. 3B to generate image data.

In step ST12, the controller 21 performs the image processing for the image processing unit. The controller 21 controls the image processing part 16 to perform the image processing, for example, such as expansion, contraction and rotation of the decoded image processing unit image.

In step ST13, the controller 21 performs the encoding of the image processing unit. The controller 21 controls the encoding/decoding part 17 to perform the encoding processing on the image processing unit image after the image processing, and to generate and output the encoded data to the sorting/marker-inserting part 18. Herein, the encoding/decoding part 17 performs the encoding processing using a correlation with an immediately preceding MCU in encoding processing order for one screen according to the instruction of the controller 21. Moreover, the encoding/decoding part 17 performs the encoding processing on an MCU immediately after an insertion position of a restart marker without using the correlation with the immediately preceding MCU according to the instruction of the controller 21. Specifically, when performing the encoding processing using the correlation with the immediately preceding MCU, in the encoding processing of the image processing unit, a DC value obtained by the encoding processing of the immediately preceding MCU in encoding processing order for one screen is stored. Further, the encoding processing of the MCU of the encoding object using the stored DC value is performed. Moreover, in the encoding processing for every image processing unit, when a DC value of an MCU immediately before a leftmost MCU in the image processing unit in encoding processing order for one screen is not stored before the encoding processing of the leftmost MCU, the DC value of the immediately preceding MCU is acquired previously. Further, the encoding processing of the MCU immediately after the insertion position of the restart marker is performed without using the correlation with the immediately preceding MCU by setting the DC value of the immediately preceding MCU to “0.”

In step ST14, the controller 21 determines whether or not the processes for the entire image processing units are completed. In the case of determination that any unprocessed image processing unit remains, the controller 21 returns the process to step ST11, and in the case of determination that the processes for the entire image processing units are completed, puts the process forward to step ST15.

In step ST15, the controller 21 sorts the encoded data in a predetermined order and inserts markers. The sorting/marker-inserting part 18 resort the encoded data for one screen held in the sorting/marker-inserting part 18 in encoding processing order for one screen, that is, in an order in which the image for one screen is to undergo the encoding processing as a whole according to the control of the controller 21. Moreover, the sorting/marker-inserting part 18 sequentially inserts restart markers in the encoded data after the sorting. The sorting/marker-inserting part 18 records the encoded data after the sorting in which the restart markers are inserted in the storage 19.

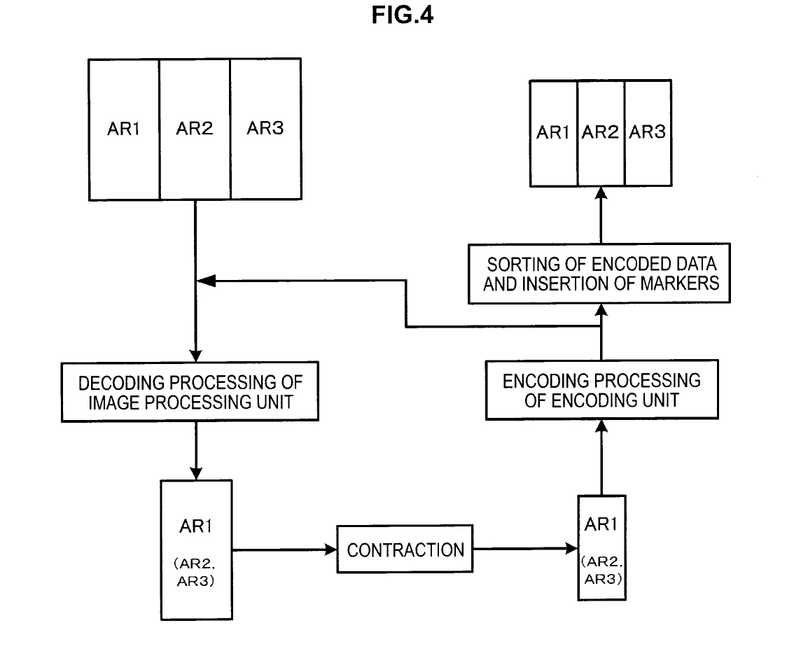

FIG. 4 is a diagram for explaining a process of contraction of an image. When reducing an image, the image capturing apparatus 10 performs the decoding processing, resizing (contraction) and encoding processing on each of image processing unit images AR1, AR2 and AR3. Further, after completion of the processes for one screen, the image capturing apparatus 10 performs sorting of encoded data, insertion of markers, and then recording in the storage 19.

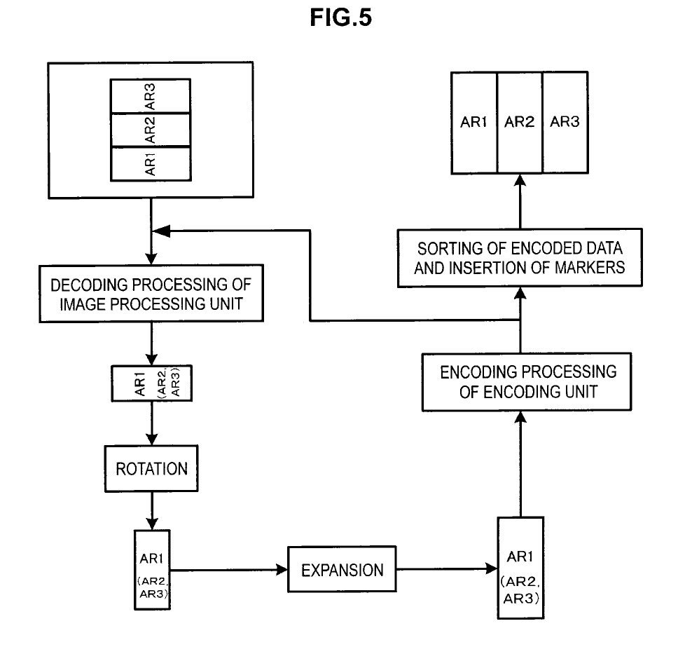

FIG. 5 is a diagram for explaining a process, for example, of rotation and expansion of an image. When rotating and expanding imaging results by image processing, the image capturing apparatus 10 performs the decoding processing, rotation, resizing (expansion) and encoding processing on each of image processing unit images AR1, AR2 and AR3. Further, after completion of the processes for one screen, the image capturing apparatus 10 performs sorting of encoded data, insertion of markers, and then recording in the storage 19. In addition, the resizing (expansion) and the rotation may be performed in this processing order conversely.

According to this embodiment, after the decoding processing, image processing and encoding processing are repeated for every image processing unit and in image processing order which are suitable for the image processing, the sorting of the encoded data for one screen generated from the individual image processing units is performed in encoding processing order for one screen. Moreover, in the sorted encoded data, restart markers as delimiting markers in the encoding processing, which uses correlations with immediately preceding encoding units, are inserted. Accordingly, the capacity of the buffer temporarily storing the encoded data for the sorting can be reduced compared with that in case of sorting of encoded data in which restart markers have been already inserted. Moreover, since the restart markers are inserted after the sorting of the encoded data, rearrangement of the indices of the restart markers in regular order is not needed and thereby, the markers can be readily inserted. Further, the encoding unit immediately after the insertion position of the restart marker undergoes the encoding processing without using the correlation with the immediately preceding encoding unit. Accordingly, since the DC value obtained by the encoding processing of the immediately preceding encoding unit in encoding processing order for one screen is not needed to be stored in the encoding processing of the image processing unit, the encoded data in which the markers are inserted can be readily generated.

In addition, depending on the sort of image processing in the image processing part 16, the image processing unit in the image data inputted to the image processing part 16 can be different from an image processing unit according to the image data outputted from the image processing part 16 in size. However, it is supposed that these image processing units are identical with each other for simplicity in the following description.

### (3. First Operation for Each Image Processing Unit)

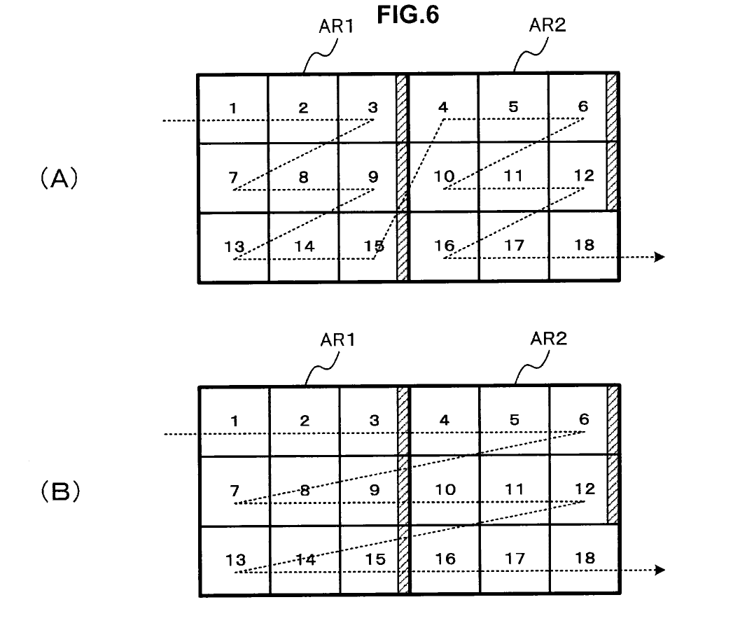

The encoding processing for each image processing unit is described below in detail. FIGS. 6A and 6B exemplarily illustrate an image processing unit image AR1 constituted of 9 MCUs 1 to 3, 7 to 9 and 13 to 15 and an image processing unit image AR2 constituted of 9 MCUs 4 to 6, 10 to 12 and 16 to 18. As illustrated in FIG. 6A, when the image processing unit image AR1 undergoes the image processing and, after that, the image processing unit image AR2 undergoes the image processing, the image AR1 undergoes the encoding processing and, after that, the image AR2 undergoes the encoding processing. Accordingly, encoded data is to be generated by performing the encoding processing on the MCUs in each image processing unit in raster scanning order as indicated by a broken line arrow.

In contrast, when the image AR1 and the image AR2 undergo the encoding processing as one image, encoded data is to be generated based on the encoding processing order for one screen as indicated by a broken line arrow in FIG. 6B. Namely, the encoded data is to be generated by performing the encoding processing on the MCUs in one image constituted of the images AR1 and AR2 in raster scanning order.

Accordingly, the sorting/marker-inserting part 18 sorts the encoded data obtained in the order illustrated in FIG. 6A in the order illustrated in FIG. 6B to output. Herein, the encoding processing by JPEG generates a DC value by storing a DC value of an immediately preceding MCU and then, for a succeeding MCU, performing the encoding processing on a difference value from the stored DC value. Accordingly, in FIG. 6A, the DC values of the MCUs 7 and 13 are obtained by the encoding of the DC values of the MCUs 3 and 9 and the difference values, respectively. Similarly, those of the MCUs 4, 10 and 16 are obtained by the encoding of the DC values of the MCUs 15, 6 and 12 and the difference values.

In contrast, when the image processing unit images AR1 and AR2 undergo the encoding processing as one image, as to the MCUs 7 and 13, the difference values from the DC values of the MCUs 6 and 12 at the rightmost end, which is the finishing end of horizontal scanning, undergo the encoding. Moreover, as to the MCUs 4, 10 and 16 on the beginning end side of horizontal scanning of the image AR2, the difference values from the DC values of the MCUs 3, 9 and 15 on the finishing end side of horizontal scanning of the image AR1 undergo the encoding.

Accordingly, the correct decoding is difficult to be attained just simply by resorting the MCU unit encoded data obtained in image processing order in encoding processing order for one screen as a whole and further reconfiguring the control codes.

Because of this, when the MCUs in the image processing unit undergo the encoding processing in raster scanning order, the controller 21 causes to store the DC values detected by the encoding/decoding part 17 as to the individual MCUs at the finishing end of horizontal scanning in this raster scanning. Moreover, the controller 21 controls the encoding/decoding part 17, when the adjacent MCUs undergo the encoding processing, to perform the encoding processing by calculating the difference value from the stored DC value. In addition, the adjacent MCUs mean adjacent MCUs after the sorting by the sorting/marker-inserting part 18.

Moreover, as to the MCU at the beginning end of horizontal scanning, it is difficult to acquire the DC value of the MCU which is an encoding reference of the DC values before the encoding processing. Accordingly, the controller 21 performs previous acquisition processing of the DC value as to the MCU for which it is difficult to prepare the DC value, that is, processing for acquiring the DC value by previously performing the decoding processing, image processing and encoding processing.

Further, the controller 21 controls the sorting/marker-inserting part 18 to insert the restart markers. Moreover, the controller 21 controls the encoding/decoding part 17 to configure the MCU immediately after the restart marker insertion position as an MCU of the reset object. For example, in FIGS. 6A and 6B, when the shaded portions at the rightmost end, which is the finishing end of horizontal scanning, in the image processing unit indicate the restart markers inserted by the sorting/marker-inserting part 18, the controller 21 configures the MCUs 4, 7, 10, 13 and 16 as the MCUs of the reset object.

In the case of FIG. 6A, the controller 21 causes to store the DC values detected by the encoding/decoding part 17 in the encoding processing of the MCUs 3, 9 and 15 at the finishing end of horizontal scanning when the image AR1 undergoes the encoding processing. Moreover, the controller 21 sets the stored DC value of the MCUs 3, 9 and 15 to the encoding/decoding part 17 individually and performs the encoding processing on the MCUs 4, 10 and 16 at the beginning end of horizontal scanning when the image AR2 undergoes the encoding processing.

Moreover, as to the MCUs 7 and 13 at the beginning end of horizontal scanning, it is difficult to acquire the DC values of the immediately preceding MCUs 6 and 12 before the encoding processing. Accordingly, the controller 21 performs the previous acquisition processing of the DC value as to the MCU for which it is difficult to prepare the DC value. Namely, the controller 21 controls operations of the individual parts so as to perform the decoding processing, image processing and encoding processing on the MCUs 6, 12 and 18 at the rightmost end illustrated in FIGS. 6A and 6B before initiating the process for the image processing unit and, after that, acquire the DC values of the MCUs 6, 12 and 18. In this case, since the previous acquisition processing of the DC values is just simply for acquiring the DC values, the encoded data obtained by the encoding processing in this is not used and is just discarded.

Further, the controller 21 controls the encoding/decoding part 17 to set the MCUs 4, 7, 10, 13 and 16 immediately after the positions at which the restart markers are to be inserted as the MCUs of the reset object.

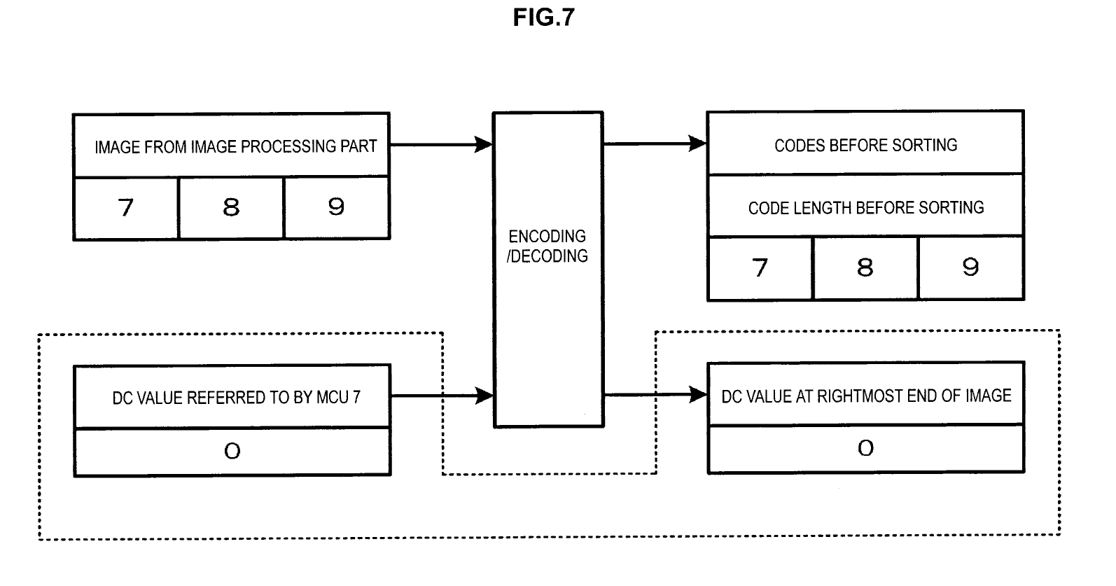

FIG. 7 exemplarily illustrates the encoding of the MCUs 7, 8 and 9. Since the MCU 7 is the reset object it should undergo the encoding using a difference between the DC value “0” and the DC value of the MCU 7. Accordingly, the controller 21 controls the encoding/decoding part 17 to replace the DC value of the immediately preceding MCU referred to in the encoding of the MCU 7 by “0.” The encoding/decoding part 17 encodes a difference value between the DC value “0” and the DC value of the MCU 7, that is, the DC value of the MCU 7. Moreover, since the MCUs 8 and 9 are not the reset object they undergo usual encoding.

Next, since the MCU 9 is the MCU at the rightmost end, which is the finishing end of horizontal scanning, the DC value obtained by the encoding of the MCU 9 is stored and used in the encoding of the DC value of the MCU 10. Herein, since the MCU 10 is the MCU of the reset object the DC value of the MCU 9 is not needed in the encoding. Accordingly, since the DC value of the MCU 9 is not needed to be stored the encoding processing can be performed readily. Similarly, for the encoding of the MCU 7 positioned at the leftmost end of one screen, the previous acquisition processing of the DC value of the MCU at the rightmost end of one screen is strongly recommended. However, when the MCU 7 is the MCU of the reset object, since the DC value at the rightmost end may be “0” the previous acquisition processing of the DC value of the MCU at the rightmost end of one screen can be omitted. Accordingly, the processing speed can be improved.

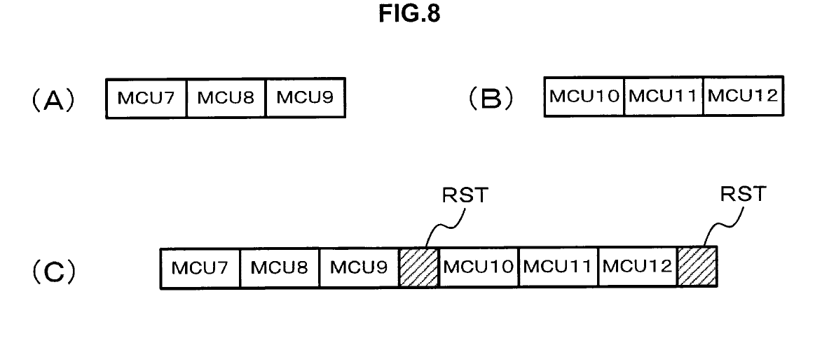

After that, the sorting of the encoded data of the image AR1 and the image AR2 is performed, which are joined with each other as illustrated in FIGS. 8A to 8C, followed by generating the encoded data for one screen. Namely, as to the MCUs 7 to 12, the encoded data of the MCUs 7, 8 and 9 illustrated in FIG. 8A is joined with the encoded data of the MCUs 10, 11 and 12 illustrated in FIG. 8B, further followed by inserting the restart markers RST and generating the encoded data in encoding processing order for one screen illustrated in FIG. 8C.

When inserting a restart marker the restart marker should undergo byte alignment and accordingly, in case without the alignment, bit stuffing is performed. Moreover, the bit stuffing possibly causes an occurrence of “0xFF,” this leading to insertion of “0x00” which is performed in case that it should be processed similarly to the rewriting of the control codes.

In addition, when, in the image processing, the image capturing apparatus 10 performs processing in which the decoded image is rotated by 180 degrees, the MCUs for which the DC values are stores are the MCUs on the beginning end side of horizontal scanning in place of the MCUs at the finishing end in horizontal scanning.

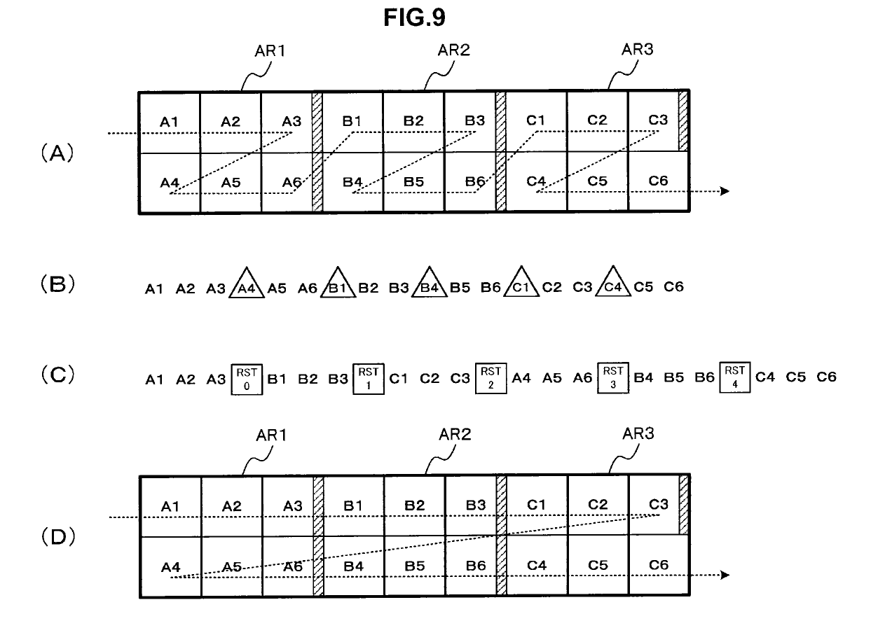

Next, FIGS. 9A to 9D illustrate a process of an image constituted of MCUs A1 to A6, B1 to B6 and C1 to C6 as image processing units. As indicated by an broken line arrow in FIG. 9A, the controller 21 sequentially decodes the image processing units of the encoded data recorded in the storage 19 in raster scanning order to generate the image data. This image data undergoes the image processing and encoding processing to sequentially generate the MCUs A1 to A6, B1 to B6 and C1 to C6 as the encoded data as illustrated in FIG. 9B.

The sorting/marker-inserting part 18 sorts the encoding units in the encoded data illustrated in FIG. 9B in encoding processing order for one screen and further, inserts the restart markers to generate the encoded data in encoding processing order for one screen, in which the restart markers are inserted as illustrated in FIG. 9C. This encoded data is in encoding processing order of an image for one screen into which the MCUs A1 to A6, B1 to B6 and C1 to C6 are integrated as indicated by a broken line arrow in FIG. 9D. The storage 19 records the encoded data illustrated in FIG. 9C. Moreover, in FIGS. 9B and 9C, the MCUs A4, B1, B4, C1 and C4, which are enclosed by the triangles, are the MCUs of the reset object and restart markers RST0, RST1, . . . are inserted immediately before the MCUs of the reset object as illustrated in FIG. 9C. In addition, the restart markers are inserted in the encoded data in encoding processing order for one screen. Accordingly, the indices of the restart markers repeat “0” to “7” and line up in encoding processing order for one screen, not needed to be rewritten.

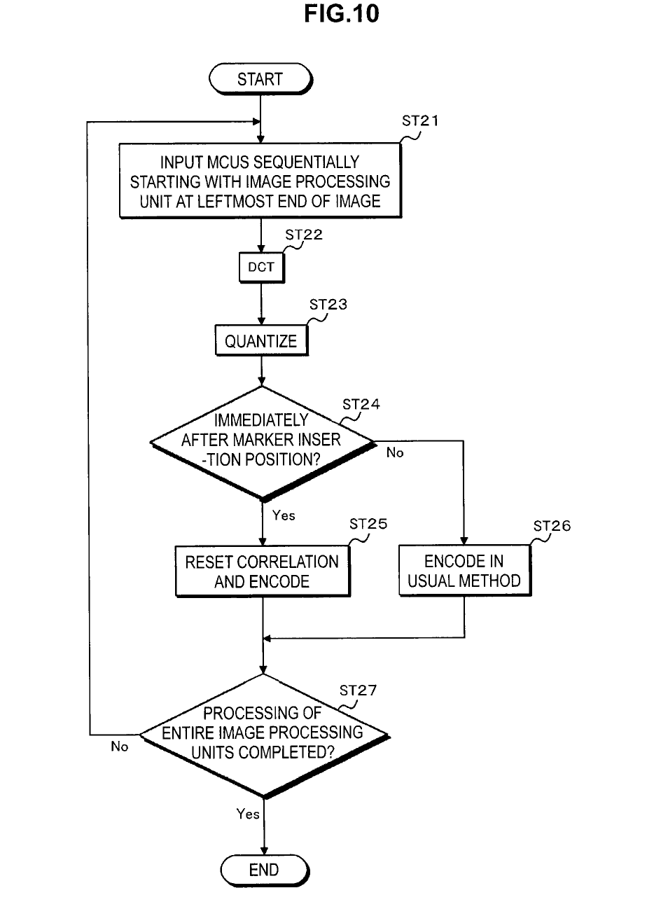

FIG. 10 is a flowchart illustrating control processing of the direct current component values in the first operation. In step ST21, the controller 21 performs input of the MCUs sequentially starting with the image processing unit at the leftmost end of the image. Moreover, when repeating the encoding processing of the image processing units, the controller 21 performs the previous acquisition processing of the DC values as to the MCUs for which it is difficult to prepare the DC values and puts the process forward to step ST22. In addition, depending on the insertion positions of the restart markers, the previous acquisition processing of the DC values can be omitted as mentioned above.

In step ST22, the controller 21 performs DCT. The controller 21 controls the encoding/decoding part 17 to perform the DCT (Discrete Cosine Transform) on each MCU in the image data and puts the process forward to step ST23.

In step ST23, the controller 21 performs quantization. The controller 21 controls the encoding/decoding part 17 to perform the quantization of coefficient data obtained by the DCT and puts the process forward to step ST24.

In step ST24, the controller 21 determines whether the MCU is immediately after the marker insertion position. The controller 21 puts the process forward to step ST25 when the processed MCU is immediately after the restart marker insertion position and puts the process forward to step ST26 when it is not immediately after that.

In step ST25, the controller 21 resets the correlation and performs the encoding. The controller 21 controls the encoding/decoding part 17 to encode the difference value between the DC value “0” and the DC value indicating the direct current component after the quantization for the MCU of the encoding object and puts the process forward to step ST27.

In step ST26, the controller 21 performs the encoding using a usual method. The controller 21 controls the encoding/decoding part 17 to encode the difference value between the DC value of the immediately preceding MCU which is stored or acquired by the previous acquisition processing and the DC value of the MCU of the encoding object and puts the process forward to step ST27.

In step ST27, the controller 21 determines whether or not the processes for the entire image processing units are completed. In the case of determination that any unprocessed image processing unit remains, the controller 21 returns the process to step ST21, and in the case of determination that the processes for the entire image processing units are completed, terminates the process.

As above, the encoding/decoding part 17 regards the MCUs immediately after the restart marker insertion positions as the reset object, and the sorting/marker-inserting part 18 sorts the encoded data in encoding processing order for one screen and inserts the restart markers as indices in a predetermined order. Accordingly, the capacity of the buffer temporarily storing the encoded data for the sorting can be reduced compared with that in case of sorting of encoded data in which restart markers have been already inserted. Moreover, rearrangement of the indices of the restart markers in regular order is not needed and thereby, the markers can be readily inserted. Further, the encoding unit immediately after the insertion position of the restart marker undergoes the encoding processing without using the correlation with the immediately preceding encoding unit. Accordingly, since the storing of the direct current component value obtained by the encoding processing of the immediately preceding encoding unit in encoding processing order for one screen and/or the previous acquisition processing of the direct current component value are not needed in the encoding processing of the image processing unit, the encoded data in which the markers are inserted can be readily generated.

### (4. Second Operation for Each Image Processing Unit)

Incidentally, the embodiment in which the insertion positions of the restart markers are at the rightmost end of the image processing units is described above, whereas the insertion position of the restart marker is not limited to locate at the rightmost end of the image processing unit. Next, an embodiment in which the insertion positions of the restart markers are in the middle of the image processing units is described below.

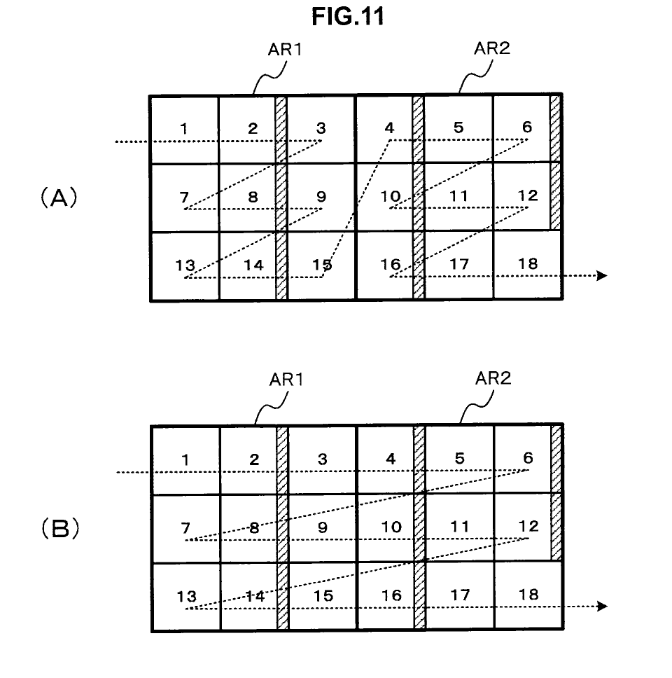

FIGS. 11A and 11B illustrate insertion of the restart markers in the middle of the image processing units. When the restart markers are provided at the right ends of the MCUs 2, 4, 6, 8, 10, 12, 14 and 16, the MCUs of the reset object are the MCUs 3, 5, 7, 9, 11, 13, 15 and 17 immediately after the restart marker insertion positions.

For the purpose of the encoding of each of image processing unit images AR1 and AR2 illustrated in FIG. 11A and the sorting of the encoded data in the order for one screen illustrated in FIG. 11B, The MCU 4 should undergo the encoding of the difference from the DC value of the MCU 3, the MCU 10 the DC value of the MCU 9, and the MCU 16 the DC value of the MCU 15.

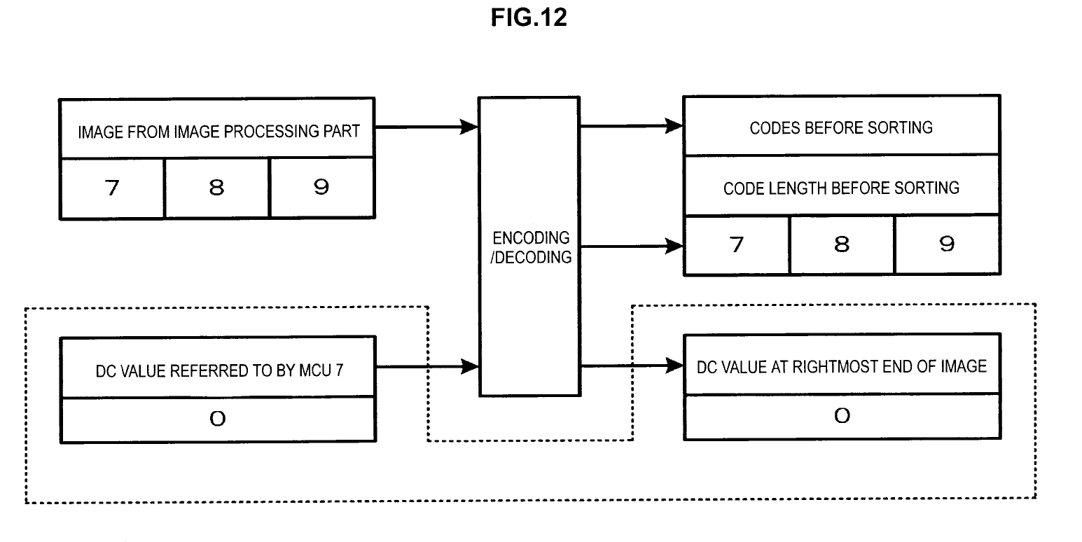

From among the MCUs in FIGS. 11A and 11B, the encoding of the MCUs 7, 8 and 9 (the MCUs 7 and 9 are the reset object) is exemplarily illustrated in FIG. 12. Since the MCUs 7 and 9 are the reset object they should undergo the encoding using differences between the DC value “0” and the DC values of the MCUs 7 and 9, respectively. Accordingly, the controller 21 controls the encoding/decoding part 17 to replace the DC values of the immediately preceding MCUs referred to in the encoding of the MCUs 7 and 9 by “0,” respectively. The encoding/decoding part 17 encodes difference values between the DC value “0” and the DC values of the MCUs 7 and 9, that is, the DC values of the MCUs 7 and 9, respectively. Moreover, since the MCU 8 is not the reset object it undergoes usual encoding.

Moreover, the DC value obtained by the encoding of the MCU 9 is stored for using in the encoding of the DC value of the MCU 10. On the other hand, for the purpose of the encoding of the MCU 7 positioned at the leftmost end of one screen, the previous acquisition processing of the DC value of the MCU at the rightmost end of one screen is strongly recommended. However, when the MCU 7 is the MCU of the reset object, since the DC value at the rightmost end may be “0” the previous acquisition processing of the DC value is not needed and the previous storing processing of the DC value of the MCU at the rightmost end of one screen can be omitted. Accordingly, the processing speed can be improved.

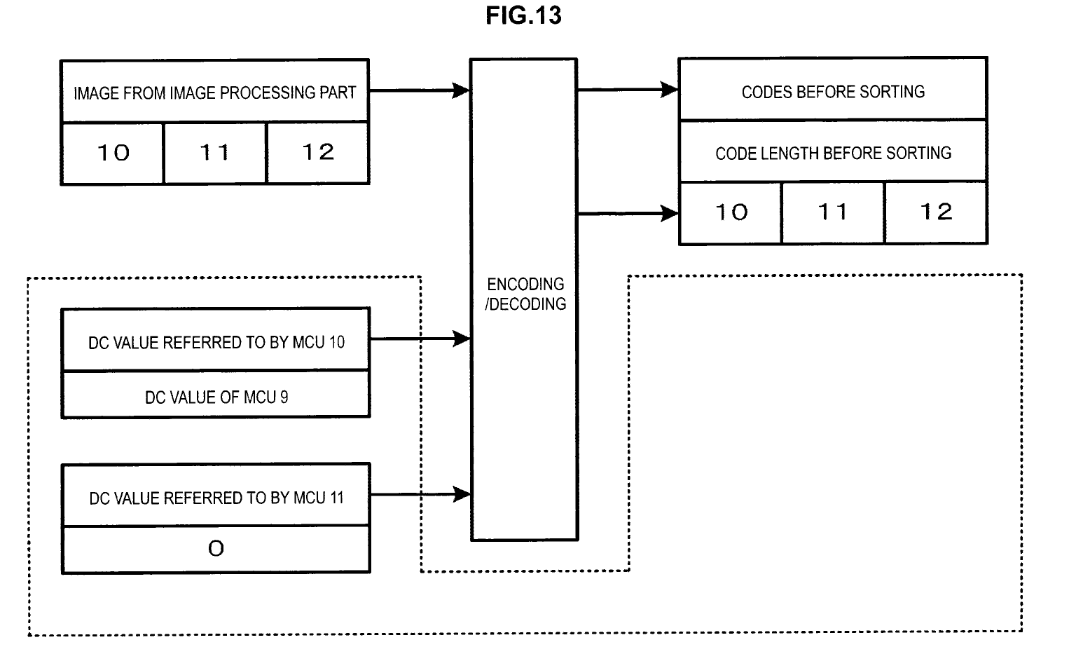

From among the MCUs in FIGS. 11A and 11B, the encoding of the MCUs 10, 11 and 12 (the MCU 11 is the reset object) is exemplarily illustrated in FIG. 13. In the encoding of the MCU 10, a difference value from the DC value of the immediately preceding MCU 9 should be calculated. Accordingly, the encoding/decoding part 17 performs the encoding by calculating the difference value using the stored DC value of the MCU 9. Moreover, since the MCU 11 is the reset object the controller 21 controls the encoding/decoding part 17 to replace the DC value of the immediately preceding MCU 10 by “0.” The encoding/decoding part 17 encodes the MCU 11 using the DC value “0.” The controller 21 performs the usual encoding on the MCU 12. Namely, a difference value from the DC value of the immediately preceding MCU 11 is calculated to perform the encoding. In addition, since the MCU 13 is the reset object the DC value of the MCU 12 is not needed in the encoding. Accordingly, since the storing of the DC value of the MCU 12 can be omitted as illustrated in FIG. 13 the processing speed can be improved.

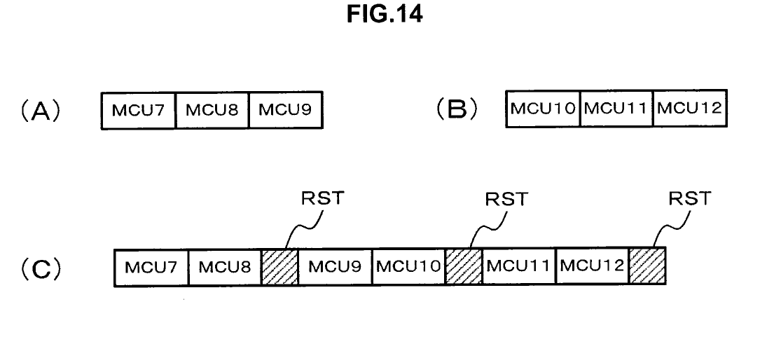

After that, the sorting of the encoded data of the image AR1 and the image AR2 is performed, which are joined with each other as illustrated in FIGS. 14A to 14C, followed by generating the encoded data for one screen. Namely, as to the MCUs 7 to 12, the encoded data of the MCUs 7, 8 and 9 illustrated in FIG. 14A is joined with the encoded data of the MCUs 10, 11 and 12 illustrated in FIG. 14B, furthermore followed by inserting the restart markers RST and generating the encoded data in encoding processing order for one screen illustrated in FIG. 14C.

Moreover, when inserting a restart marker the restart marker should undergo byte alignment and accordingly, in case without the alignment, bit stuffing is performed. Moreover, the bit stuffing possibly causes an occurrence of “0xFF,” this leading to insertion of “0x00” which is performed in case that it should be processed similarly to the rewriting of the control codes.

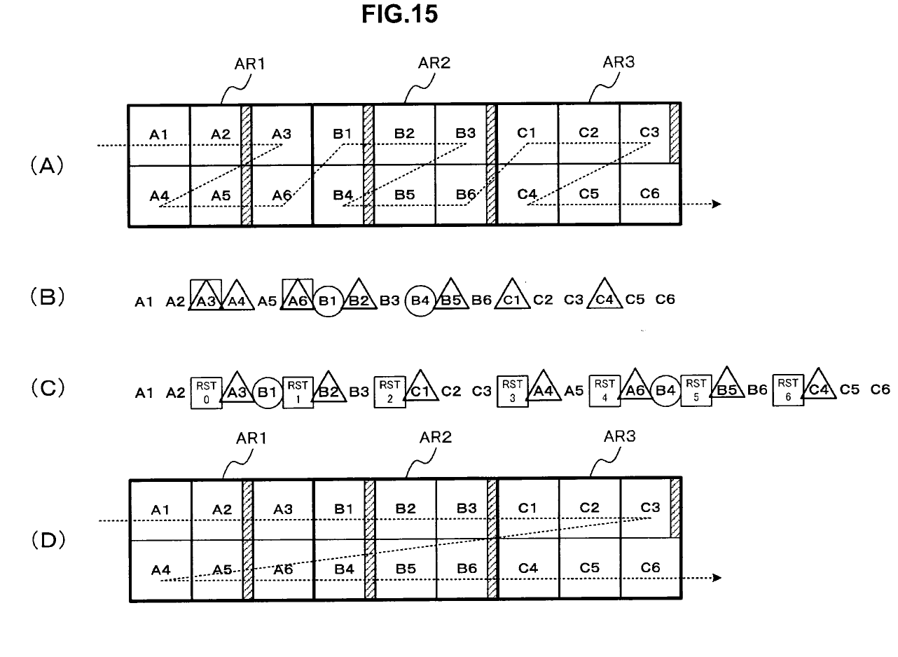

Next, FIGS. 15A to 15D illustrate a process of an image constituted of MCUs A1 to A6, B1 to B6 and C1 to C6 as image processing units. As indicated by an broken line arrow in FIG. 15A, the controller 21 sequentially decodes the image processing units of the encoded data recorded in the storage 19 in raster scanning order to generate the image data. This image data undergoes the image processing and encoding processing to sequentially generate the MCUs A1 to A6, B1 to B6 and C1 to C6 as the encoded data as illustrated in FIG. 15B.

The sorting/marker-inserting part 18 sorts the encoding units in the encoded data illustrated in FIG. 15B in encoding processing order for one screen and furthermore, inserts the restart markers to generate the encoded data in encoding processing order for one screen, in which the restart markers RST are inserted as illustrated in FIG. 15C. This encoded data is in image encoding processing order for one screen into which the MCUs A1 to A6, B1 to B6 and C1 to C6 are integrated as indicated by a broken line arrow in FIG. 15D. The storage 19 records the encoded data illustrated in FIG. 15C.

In addition, in FIGS. 15B and 15C, the MCUs which locate immediately after the restart markers and are indicated by the triangles are the MCUs of the reset object and undergo the encoding of the difference values between the DC value “0” and the DC values of the MCUs, that is, the DC values of the MCUs indicated by the triangles. The MCUs indicated by the squares in FIG. 15B are the MCUs for which the DC values are stored. The MCUs indicated by the circles in FIGS. 15B and 15C are the MCUs for which the encoding is performed using the DC values of the immediately preceding MCUs in encoding processing order for one screen.

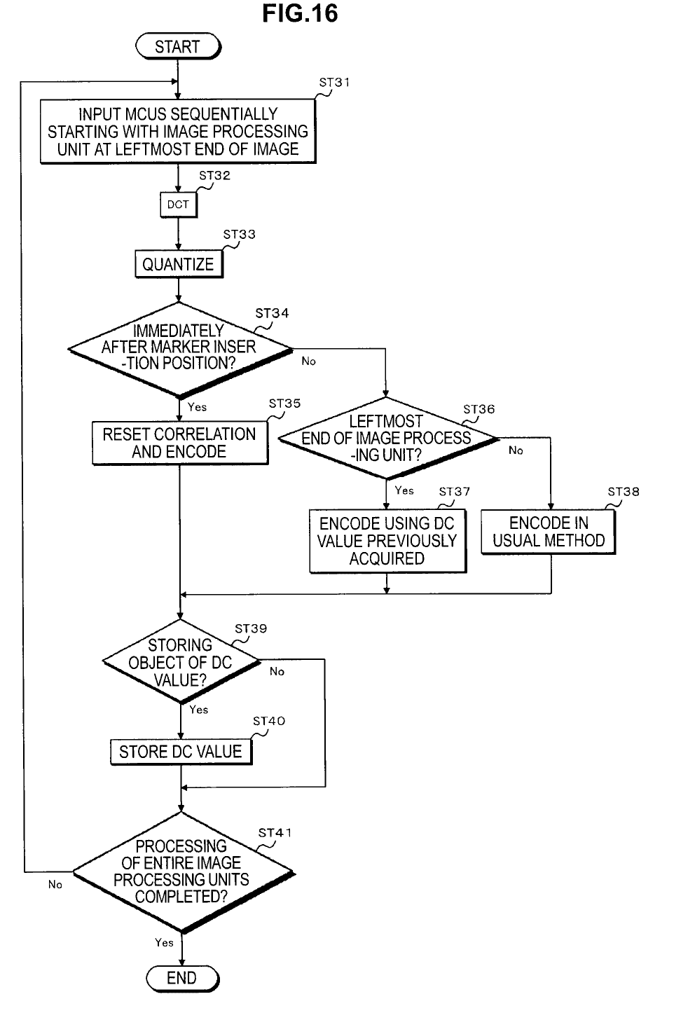

FIG. 16 is a flowchart illustrating control processing of the direct current component values in the second operation. In step ST31, the controller 21 performs input of the MCUs sequentially starting with the image processing unit at the leftmost end of the image. Moreover, when repeating the encoding processing of the image processing units, the controller 21 performs the previous acquisition processing of the DC values of the MCUs for which it is difficult to prepare the DC values and puts the process forward to step ST32. In addition, depending on the insertion positions of the restart markers, the previous acquisition processing of the DC values can be omitted as mentioned above.

In step ST32, the controller 21 performs DCT. The controller 21 controls the encoding/decoding part 17 to perform the discrete cosine transform on each MCU in the image data and puts the process forward to step ST33.

In step ST33, the controller 21 performs quantization. The controller 21 controls the encoding/decoding part 17 to perform the quantization of coefficient data obtained by the discrete cosine transform and puts the process forward to step ST34.

In step ST34, the controller 21 determines whether the MCU is immediately after the marker insertion position. The controller 21 puts the process forward to step ST35 when the processed MCU is immediately after the restart marker insertion position and puts the process forward to step ST36 when it is not immediately after the restart marker insertion position.

In step ST35, the controller 21 resets the correlation and performs the encoding. The controller 21 controls the encoding/decoding part 17 to encode the difference value between the DC value “0” and the DC value indicating the direct current component after the quantization for the MCU of the encoding object, that is, the DC value of the MCU of the encoding object and puts the process forward to step ST39.

In step ST36, the controller 21 determines whether the MCU of the encoding object is at the leftmost end of the image processing unit. The controller 21 puts the process forward to step ST37 when the MCU of the encoding object is at the leftmost end of the image processing unit, and puts the process forward to step ST38 when it is not at the leftmost end.

In step ST37, the controller 21 performs the encoding using the previously acquired DC value. Since the MCU is at the leftmost end of the image processing unit, the controller 21 encodes the difference value between the previously acquired DC value and the DC value of the MCU of the encoding object and puts the process forward to step ST39.

In step ST38, the controller 21 performs the encoding using a usual method. The controller 21 controls the encoding/decoding part 17 to encode the difference value between the DC value of the immediately preceding MCU and the DC value of the MCU of the encoding object and puts the process forward to step ST39.

In step ST39, the controller 21 determines whether the MCU is the object for which the DC value is stored. Herein, when the next MCU is the reset object the DC value of the MCU immediately before the restart marker insertion position is not needed for the encoding of the next MCU. Moreover, the DC value of the MCU not at the rightmost end of the image processing unit is not needed for the encoding of the next image processing unit. Accordingly, when the MCU of the encoding object is not the MCU immediately before the restart marker insertion position and is at the rightmost of the image processing unit, the controller 21 determines that the MCU is the object for which the DC value is stored and puts the process forward to step ST40. Moreover, when the MCU of the encoding object is the MCU immediately before the restart marker insertion position or is at the rightmost of the image processing unit, the controller 21 determines that the MCU is not the object for which the DC value is stored and puts the process forward to step ST41.

In step ST40, the controller 21 stores the DC value. The controller 21 causes to store the DC value of the MCU of the encoding object so that it can be used for the encoding of the following MCU and puts the process forward to step ST41.

In step ST41, the controller 21 determines whether the processes for the entire image processing units are completed. In the case of determination that any unprocessed image processing unit remains, the controller 21 returns the process to step ST31, and in the case of determination that the processes for the entire image processing units are completed, terminates the process.

Also as above in the second operation, the encoding/decoding part 17 regards the MCUs immediately after the restart marker insertion positions as the reset object. Moreover, the sorting/marker-inserting part 18 sorts the encoded data in encoding processing order for one screen and inserts the restart markers as indices in a predetermined order. Accordingly, the capacity of the buffer temporarily storing the encoded data for the sorting can be reduced compared with that in case of sorting of encoded data in which restart markers have been already inserted. Moreover, rearrangement of the indices of the restart markers in regular order is not needed and thereby, the markers can be readily inserted. Furthermore, the encoding unit immediately after the insertion position of the restart marker undergoes the encoding processing without using the correlation with the immediately preceding encoding unit. Accordingly, since the storing of the direct current component value obtained by the encoding processing of the immediately preceding encoding unit in encoding processing order for one screen and/or the previous acquisition processing of the direct current component value are not needed in the encoding processing of the image processing unit, the encoded data in which the markers are inserted can be readily generated.

### (5. Third Operation for Each Image Processing Unit)

As above, the first and second operations, in which the image does not change its direction, are described, whereas a third operation in which the image undergoes rotation in the image processing is described below.

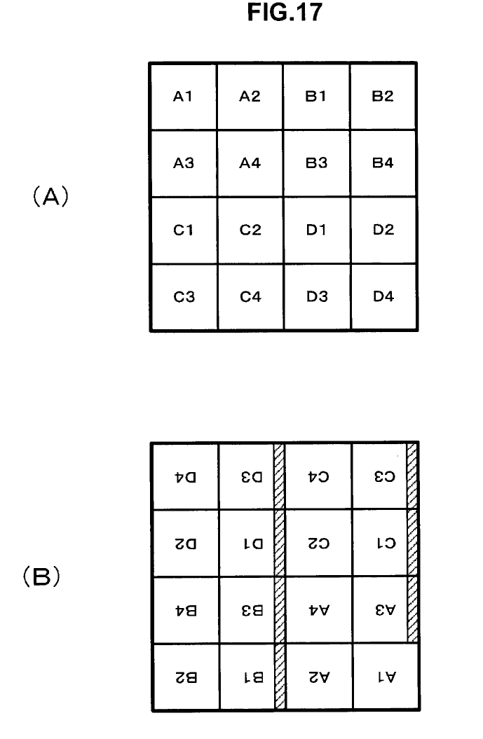

FIGS. 17A and 17B illustrate rotation of an image by 180 degrees in the image processing. FIG. 17A illustrates the image before the rotation and FIG. 17B illustrates image after the rotation. Moreover, the MCUs A1 to A4 constitute one image processing unit. Similarly, the MCUs B1 to B4, C1 to C4 and D1 to D4 constitute image processing units, respectively. Moreover, shaded portions in FIG. 17B indicate insertion positions of restart markers.

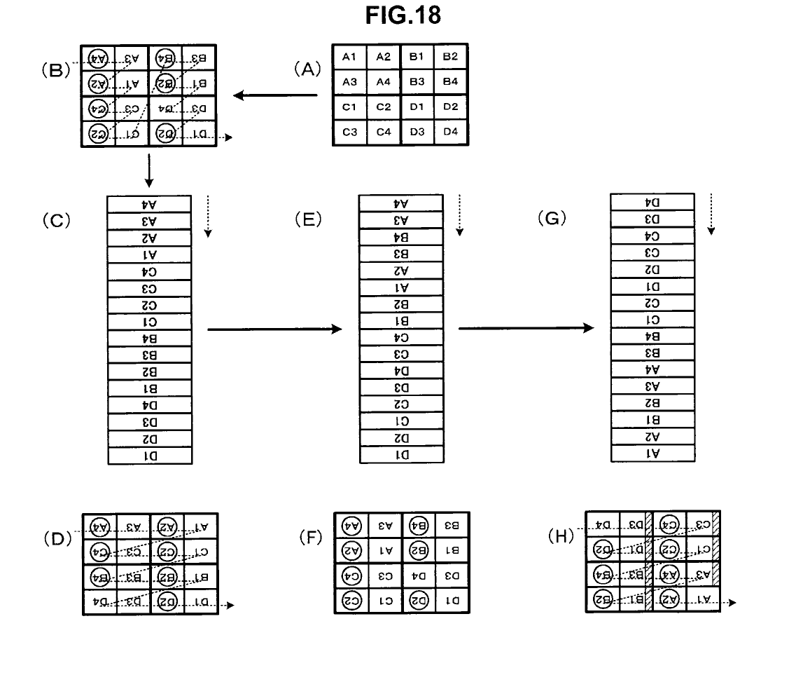

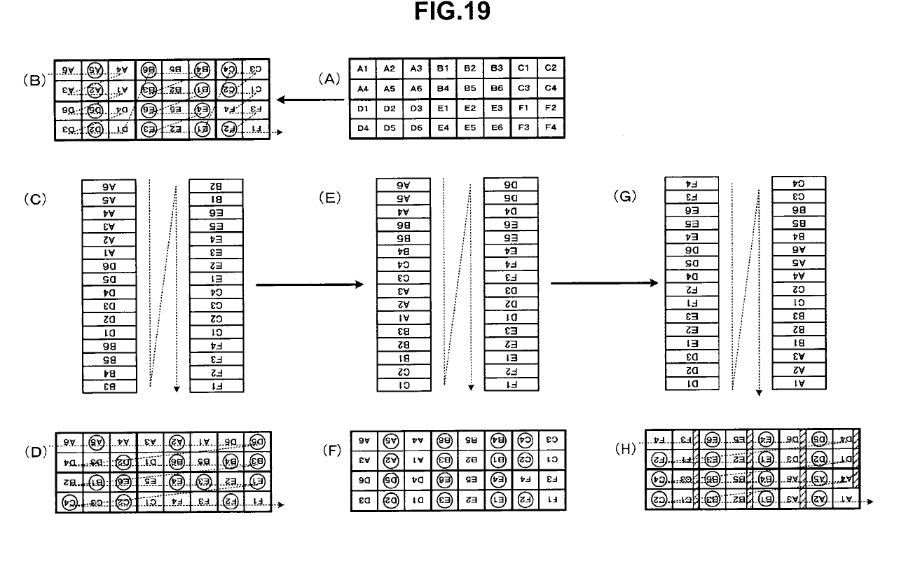

FIG. 18 is a diagram for explaining the sorting processing in the case of the rotation of the image by 180 degrees in the image processing. The controller 21 performs control of the image processing of rotation of image processing units in the image, for example, by 180 degrees, the encoding processing thereof and the sorting thereof to output. In addition, in FIG. 18, and in FIG. 19 described below, the characters turned upside down indicate data regarding the image rotated by 180 degrees.

As indicated by the broken line arrow, the controller 21 decodes the image processing unit of the MCUs A1 to A4, the image processing unit of the MCUs C1 to C4, the image processing unit of the MCUs B1 to B4 and the image processing unit of the MCUs D1 to D4 in the encoded data in this order to generate the image data. The controller 21 temporarily stores the image data as the decoding results outputted from the encoding/decoding part 17 in this order in the buffer memory, rotates the individual image processing units in the image by address control of this buffer memory by 180 degrees, and inputs them to the image processing part 16.

In addition, the rotation of the image may be performed by the rotation of the individual image processing units by address control during the storing and the outputting of the image processing results outputted from the image processing part 16 in/from the buffer memory.

The controller 21 controls the image processing part 16 to rotate the individual image processing units in the image illustrated in portion A of FIG. 18 by 180 degrees to perform the image processing as the image illustrated in portion B of FIG. 18. Moreover, the controller 21 causes the encoding/decoding part 17 to perform the encoding processing on the image data as the image processing results to generate the encoded data in the order illustrated in portion C of FIG. 18. As to the encoded data in this order, the MCUs of each image processing unit in the encoded data are in raster scanning order as illustrated in portion D of FIG. 18.

The controller 21 controls the sorting/marker-inserting part 18 to sort the encoded data in the order illustrated in portion C of FIG. 18 in the order illustrated in portion E of FIG. 18, that is, to sort the MCUs of each image processing unit in the encoded data in raster order for one screen which is rotated by 180 degrees as illustrated in portion F of FIG. 18. After that, the sorting/marker-inserting part 18 sorts the encoded data in the order illustrated in portion E of FIG. 18 in the order illustrated in portion G of FIG. 18, that is, sorts the image processing units in the encoded data so that the order of the image processing units are the order for one screen which is rotated by 180 degrees, that is, the order illustrated in portion H of FIG. 18.

In such processes, the controller 21 stores the DC values obtained by the sequential encoding processing of the individual image processing units so that the stored DC values can be used for the encoding processing of the following image processing units. Furthermore, during the sequential encoding processing of the individual image processing units, when the DC values of the immediately preceding MCUs are not stored, the previous acquisition processing of the DC values is performed to acquire only the DC values.

Furthermore, the controller 21 previously sets the DC values which are referred to for the MCUs of the reset object to “0” in the encoding processing of the image processing results illustrated in portion B of FIG. 18, so as to reset the correlations with the immediately preceding MCUs at the restart marker insertion positions in the encoded data after the sorting, that is, in the encoded data in the order illustrated in portion G of FIG. 18. For example, when the restart markers are inserted at the positions of the shaded portions in portion H of FIG. 18, the MCUs indicated by the circles in FIG. 18 are the reset object. Accordingly, the DC values which are used for the calculation of the difference values in the encoding of the MCUs indicated by the circles are set to “0.”

When the restart markers are inserted at the positions of the shaded portions in portion H of FIG. 18, the DC values which are used for the calculation of the difference values regarding the MCUs D2, B4, B2, C4, C2, A4 and A2 should be set. However, since these MCUs are the reset object, the DC values which are referred to may be simply set to “0,” and the storing of the DC values of the MCUs C3, C1 and A3 or the previously acquiring of the DC values of the MCUs B1, B3, D1 and D3 is not needed.

FIG. 19 is a diagram for explaining the sorting processing in the case that the restart markers are inserted in the middle of the image processing units.

The controller 21 controls the image processing part 16 to rotate the individual image processing units in the image illustrated in portion A of FIG. 19 by 180 degrees to perform the image processing as the image illustrated in portion B of FIG. 19. The controller 21 causes the encoding/decoding part 17 to perform the encoding processing on the image data as the image processing results to generate the encoded data in the order illustrated in portion C of FIG. 19. As to the encoded data in this order, the MCUs of each image processing unit in the encoded data are in raster scanning order as illustrated in portion D of FIG. 19.

The controller 21 controls the sorting/marker-inserting part 18 to sort the encoded data in the order illustrated in portion C of FIG. 19 in the order illustrated in portion E of FIG. 19, that is, to sort the MCUs of each image processing unit in the encoded data in raster order for one screen which is rotated by 180 degrees as illustrated in portion F of FIG. 19. After that, the sorting/marker-inserting part 18 sorts the encoded data in the order illustrated in portion E of FIG. 19 in the order illustrated in portion G of FIG. 19, that is, sorts the image processing units in the encoded data so that the order of the image processing units are the order for one screen which is rotated by 180 degrees, that is, the order illustrated in portion H of FIG. 19.

In such processes, the controller 21 stores the DC values obtained by the sequential encoding processing of the individual image processing units so that the stored DC values can be used for the encoding processing of the following image processing units. Furthermore, during the sequential encoding processing of the individual image processing units, when the DC values of the immediately preceding MCUs are not stored, the previous acquisition processing of the DC values is performed to acquire only the DC values.

Furthermore, the controller 21 previously sets the DC values which are referred to for the MCUs of the reset object to “0” in the encoding of the image processing results illustrated in portion B of FIG. 19, so as to reset the correlations with the immediately preceding MCUs at the restart marker insertion positions in the encoded data after the sorting, that is, in the encoded data in the order illustrated in portion G of FIG. 19. For example, when the restart markers are inserted at the positions of the shaded portions in portion H of FIG. 19, the MCUs indicated by the circles in FIG. 19 are the reset object. Accordingly, the DC values which are used for the calculation of the difference values in the encoding of the MCUs indicated by the circles are set to “0.”

When the restart markers are inserted at the positions of the shaded portions in portion H of FIG. 19, the DC values which are used for the calculation of the difference values regarding the MCUs A3, A6, D3, D6, B3, B6, E3, E6, C2, C4 and F2 should be set. Herein, since the MCUs B3, B6, E3, E6, C2, C4 and F2 are the reset object, the DC values which are referred to may be simply set to “0,” and the storing of the DC values of the MCUs A4, D1 and D4 or the previously acquiring of the DC values of the MCUs C1, C3, F1 and F3 is not needed. Moreover, since the MCUs A3, A6, D3 and D6 are not the reset object, the DC values of the MCUs B1, B4, E1 and E4 are previously acquired.

Moreover, in FIGS. 18 and 19, the individual image processing units in the image undergo the rotation, after that, the image processing and encoding processing, and after that, the sorting in the above description, whereas the individual MCUs in the image may undergo the rotation, after that, the image processing and encoding processing, and after that, the sorting.

In this case, the controller 21 decodes the individual image processing units in raster scanning order, stores the image data in the buffer memory, rotates the individual MCUs in the image by 180 degrees by address control of this buffer memory, and supplies the image data to the image processing part 16. Moreover, the image processing part 16 performs the image processing on the image data, followed by the sequential encoding processing thereof by the encoding/decoding part 17. Also in this case, the rotation of the individual MCUs in the image by address control may be performed during the storing and the outputting of the image processing results outputted from the image processing part 16 in/from the buffer memory. Moreover, after storing the encoded data thus sequentially obtained like this, the sorting/marker-inserting part 18 performs the sorting.

In the encoding processing of the successive image processing units and further the previous processing, the controller 21 stores the DC values of the MCUs and sets these DC values to the encoding/decoding part 17 to perform the encoding processing.

Moreover, as to the adjacent MCUs in one image processing unit in the horizontal direction, the direction in which the MCUs are horizontally scanned in the encoding is opposite to that in the outputting from the sorting/marker-inserting part 18. Therefore, in the processing of these adjacent MCUs the controller 21 acquires and holds the DC values of the MCUs by the previous processing and performs the encoding processing on the MCUs using the held DC values so as to deal with this reversal of the scanning directions.

As above, the encoding/decoding part 17 decodes the image processing unit in the encoded data recorded in the storage 19 for the image processing part 16, and the image processing part 16 performs the image processing on it. Moreover, the encoding/decoding part 17 performs the encoding processing on the image data which has undergone the image processing, and the sorting/marker-inserting part 18 holds the encoded data as the processing result. Furthermore, the decoding, image processing and encoding processing of the image processing units are repeated in the order of the image processing in the image processing part 16 Herein, upon completion of the processes for one screen, the sorting/marker-inserting part 18 sorts the encoded data and inserts the restart markers, and the storage 19 records the encoded data.

In this case, the buffer memory recording the image processing results in the image capturing apparatus 10 merely expects a capacity for storing the image data just for one image processing unit. Thereby, the capacity of this buffer memory can be reduced. Furthermore, this reduction can lead to the reduction of power consumption and the reduction of time for the image processing.

Furthermore, when performing the decoding processing, image processing and encoding processing on the image processing unit, the buffer memory can be shared both for temporarily storing the encoding processing results and for temporarily storing the image processing results, and thus the configuration can be simplified.

When performing a series of the processes on the image processing unit, the image capturing apparatus 10 stores the DC values detected in the encoding processing and uses them in the encoding processing of the following image processing units. Moreover, as to the DC values of the MCUs for which it is difficult to be previously prepared, by the previous acquisition processing of the DC values before the repetition of the series of these processes, the DC values are acquired by performing the decoding, image processing and encoding processing on the relevant MCUs. Furthermore, since the MCUs immediately after the restart marker insertion positions are configured as the MCUs of the object for which the correlations are reset and undergo the encoding processing, the encoded data in which the restart markers are inserted in encoding order in one screen can be correctly generated.

Moreover, even when performing the rotation of the image or the like, the encoding/decoding part 17 regards the MCUs immediately after the restart marker insertion positions as the reset object. Moreover, the sorting/marker-inserting part 18 sorts the encoded data in encoding processing order for one screen and, after that, inserts the restart markers as indices in a predetermined order. Accordingly, the capacity of the buffer temporarily storing the encoded data for the sorting can be reduced compared with that in case of sorting of encoded data in which restart markers have been already inserted. Moreover, rearrangement of the indices of the restart markers in regular order is not needed and thereby, the markers can be readily inserted. Furthermore, the encoding unit immediately after the insertion position of the restart marker undergoes the encoding processing without using the correlation with the immediately preceding encoding unit. Accordingly, since the storing of the direct current component value obtained by the encoding processing of the immediately preceding encoding unit in encoding processing order for one screen and/or the previous acquisition processing of the direct current component value are not needed in the encoding processing of the image processing unit, the encoded data in which the markers are inserted can be readily generated.

In addition, in the description of the above-mentioned embodiments, the present technology is applied to the image processing such as scaling and rotation, whereas the present technology is not limited to this but can be widely applied to image processing according to various effects such as white-black reversal, various kinds of image processing such as distortion correction, correction of chromatic aberration and noise reduction. Furthermore, other than the recoding of the image after the image processing and then the encoding processing, the present technology can also be applied to, for example, the encoding of the stored image after the temporary storing of the image data of the captured image in the memory or the like, followed by storing it in the storage 19.

Moreover, in the above-mentioned embodiments, the processing of the still image in JPEG is described, whereas the present technology is not limited to this but can be widely applied to, for example, the encoding processing of the similar encoding processing units in MPEG (Moving Picture Experts Group) or the like.

### (6. In Case of Software Processing)

Incidentally, a series of the processes described in the present specification can be executed by hardware, software, or a combination of both. The software can execute the processes by installing a program recording a processing sequence into a memory in a computer integrated with dedicated hardware, or by installing the program in a general purpose computer executable of various processes.

For example, the program can previously be recorded in a hard disk drive, ROM (Read Only Memory) or the like as a recording medium. Or the program can temporarily or permanently be stored (recorded) in a removable medium such as a flexible disk, CD-ROM (Compact Disc Read Only Memory), MO (Magneto optical) disk, DVD (Digital Versatile Disc), magnetic disk, semiconductor memory card. Such a removable recording medium can be provided as so-called packaged software.

Moreover, the program not only be installed in the computer form the removable recording medium but also may be installed by wireless or wired transferring into the computer via a network such as a LAN (Local Area Network) and the Internet from download sites. The computer can undergo installation of the received program, which is transferred like that, into the recording medium such as the mounted hard disk drive.

In addition, the various processes described in the present specification may not only be executed in time-series according to the description but also be executed in parallel or individually depending on the performance in which the apparatus executes the processes or as necessary. Moreover, a system in the present specification is taken as a logical aggregate of a plurality of devices and is not limited to a structure in which the individual component devices are integrated in the same housing.

It should be understood by those skilled in the art that various modifications, combinations, sub-combinations and alterations may occur depending on design requirements and other factors insofar as they are within the scope of the appended claims or the equivalents thereof

Additionally, the present technology may also be configured as below.

### (1) An Image Encoding Apparatus Including:

an encoding part performing encoding processing on each image processing unit including a plurality of encoding units and generating encoded data; and a sorting/marker-inserting part sorting the encoding units in the encoded data in encoding processing order for one screen and inserting a marker as a delimiter for encoding processing using a correlation with an immediately preceding encoding unit.

(2) The image encoding apparatus according to (1), wherein the encoding part encodes a difference between a direct current component value obtained by the encoding processing on the immediately preceding encoding unit and a direct current component value obtained by the encoding processing on an encoding object as the encoding processing using the correlation with the immediately preceding encoding unit.
(3) The image encoding apparatus according to (2), wherein the encoding part performs, for an encoding unit immediately after an insertion position of the marker, the encoding processing by setting the direct current component value obtained by the encoding processing on the immediately preceding encoding unit to “0.”
(4) The image encoding apparatus according to any one of (1) to (3), further including

an image processing part performing image processing on each of the image processing units, wherein

the encoding part performs the encoding processing on an image on which the image processing is performed.

(5) The image encoding apparatus according to (4), wherein

the image processing part performs rotation of each of the image processing units or each of the encoding units when performing rotation of the image as the image processing, and

the sorting/marker-inserting part sorts the encoding units in the encoded data in encoding processing order for one screen of the image after the rotation.

(6) The image encoding apparatus according to any one of (1) to (5), wherein the encoding part stores, when performing the encoding processing using a correlation with an immediately preceding encoding unit, a direct current component value obtained by the encoding processing on the immediately preceding encoding unit in the encoding processing order for one screen, and performs the encoding processing on the encoding unit as an encoding object using the stored direct current component value.
(7) The image encoding apparatus according to any one of (1) to (6), wherein, when performing the encoding processing on each of the image processing units in case that a direct current component value of an encoding unit immediately before an encoding unit at a leftmost end in the image processing unit in the encoding processing order for one screen is not stored before the encoding processing on the encoding unit at the leftmost end, the encoding part previously acquires the direct current component value of the immediately preceding encoding unit.

In an image encoding apparatus, an image encoding method and a program according to the present technology, the encoding processing on each image processing unit constituted of a plurality of encoding units is performed and the encoded data is generated. Moreover, the encoding units in the encoded data are sorted in encoding processing order for one screen and, in it, markers as delimiters for the encoding processing using correlations with immediately preceding encoding processing units are inserted. Thus, since the markers are inserted after the sorting of the encoded data in encoding processing order for one screen, the buffer capacity temporarily storing the encoded data can be reduced. Moreover, since the markers are inserted after the sorting of the encoded data in encoding processing order for one screen, rearrangement of the indices of the markers in a predetermined order in one screen is not needed and the generation of the encoded data in which the marker are inserted is performed readily. Accordingly, wide applications to various kinds of electronic equipment loading image processing functions, for example, such as an image capturing apparatus, image editing apparatus, personal computer, mobile terminal and mobile phone are possible.

The present disclosure contains subject matter related to that disclosed in Japanese Priority Patent Application JP 2011-183556 filed in the Japan Patent Office on Aug. 25, 2011, the entire content of which is hereby incorporated by reference.

What is claimed is:

1. An image encoding apparatus comprising:
an encoding part performing encoding processing on each image processing unit including a plurality of encoding units and generating encoded data; and
a sorting/marker-inserting part sorting the encoding units in the encoded data in encoding processing order for one screen and inserting a marker as a delimiter for encoding processing using a correlation with an immediately preceding encoding unit.

2. The image encoding apparatus according to claim 1, wherein the encoding part encodes a difference between a direct current component value obtained by the encoding processing on the immediately preceding encoding unit and a direct current component value obtained by the encoding processing on an encoding object as the encoding processing using the correlation with the immediately preceding encoding unit.

3. The image encoding apparatus according to claim 2, wherein the encoding part performs, for an encoding unit immediately after an insertion position of the marker, the encoding processing by setting the direct current component value obtained by the encoding processing on the immediately preceding encoding unit to “0.”

4. The image encoding apparatus according to claim 1, further comprising
an image processing part performing image processing on each of the image processing units, wherein
the encoding part performs the encoding processing on an image on which the image processing is performed.

5. The image encoding apparatus according to claim 4, wherein
the image processing part performs rotation of each of the image processing units or each of the encoding units when performing rotation of the image as the image processing, and
the sorting/marker-inserting part sorts the encoding units in the encoded data in encoding processing order for one screen of the image after the rotation.

6. The image encoding apparatus according to claim 1, wherein the encoding part stores, when performing the encoding processing using a correlation with an immediately preceding encoding unit, a direct current component value obtained by the encoding processing on the immediately preceding encoding unit in the encoding processing order for one screen, and performs the encoding processing on the encoding unit as an encoding object using the stored direct current component value.

7. The image encoding apparatus according to claim 1, wherein, when performing the encoding processing on each of the image processing units in case that a direct current component value of an encoding unit immediately before an encoding unit at a leftmost end in the image processing unit in the encoding processing order for one screen is not stored before the encoding processing on the encoding unit at the leftmost end, the encoding part previously acquires the direct current component value of the immediately preceding encoding unit.

8. An image encoding method comprising:
performing encoding processing on each image processing unit including a plurality of encoding units and generating encoded data; and
sorting the encoding units in the encoded data in encoding processing order for one screen and inserting a marker as a delimiter for encoding processing using a correlation with an immediately preceding encoding unit.

9. A program causing a computer to perform encoding of an image, causing the computer to execute:
performing encoding processing on each image processing unit including a plurality of encoding units and generating encoded data; and
sorting the encoding units in the encoded data in encoding processing order for one screen and inserting a marker as a delimiter for encoding processing using a correlation with an immediately preceding encoding unit.
